(19) United States
(12) Patent Application Publication
(10) Pub. No.: US 2019/0362226 A1
(43) Pub. Date: Nov. 28, 2019

(54) Facilitate Transfer Learning Through Image Transformation

(71) Applicant: International Business Machines Corporation, Armonk, NY (US)

(72) Inventors: David Richmond, Newton, MA (US); Yiting Xie, Cambridge, MA (US)

(21) Appl. No.: 15/987,811

(22) Filed: May 23, 2018

(51) Int. Cl. G06N 3/08; G06K 9/62

(52) U.S. Cl. CPC G06N 3/08; G06K 9/6262; G06K 9/6256

(57) ABSTRACT

An approach is provided to transform a first set of images retrieved from an annotated source image dataset. The transformation is based on image characteristics found in a model's domain, such as grayscale medical images. The first set of images can be common images unrelated to the model's domain. The approach pre-tunes the model by using the transformed images. The model is included in a question-answering (QA) system. The approach further trains the model using a second set of annotated images with the second set of images corresponding to the target domain, such as medical images. After training, a image, such as a medical image, is received at the QA system. The received image already has image characteristics of the target domain and no transformation is needed. The QA system responsively provides predictions pertaining to the received image.

### BACKGROUND

Deep learning methods have achieved state-of-the-art performance on many image analysis tasks. These methods typically require very large and rich training datasets to achieve optimal performance (often in the scale of many thousands to millions of images). Furthermore, for supervised learning, the training datasets need to be labeled.

Large labeled datasets are abundant in certain domains (e.g. photographs and other natural images) and scarce in other domains. Therefore, transfer learning is commonly used to transfer the learned basic image features, such as edges and textures, from large labeled datasets (source domain) to smaller, more specialized datasets (target domain). However, there is often a fundamental difference between data in the source domain and the target domain. For example, in a medical application, natural images are typically in color while most medical images, such as x-ray images, are grayscale.

### BRIEF SUMMARY

An approach is provided to transform a first set of images retrieved from an annotated source image dataset. The transformation is based on image characteristics found in a model's domain, also referred to as a target domain, such as grayscale medical images. The first set of images can be common images unrelated to the model's domain. The approach pre-tunes the model by using the transformed images. The model may be included in a question-answering (QA) system. The approach further trains the model using a second set of annotated images with the second set of images corresponding to the target domain, such as medical images. After training, a image, such as a medical image, is received at the QA system. The received image already has image characteristics of the target domain and no transformation is needed. The QA system responsively provides predictions pertaining to the received image.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE SEVERAL VIEWS OF THE DRAWINGS

The present invention may be better understood, and its numerous objects, features, and advantages made apparent to those skilled in the art by referencing the accompanying drawings, wherein:

FIG. 1 depicts a schematic diagram of one illustrative embodiment of a question/answer creation (QA) system in a computer network;

FIG. 2 illustrates an information handling system, more particularly, a processor and common components, which is a simplified example of a computer system capable of performing the computing operations described herein;

FIG. 3 is a system diagram depicting the components utilized to facilitate transfer learning through image transformation;

FIG. 4 is a higher level flowchart showing basic steps performed to facilitate transfer learning through image transformation;

FIG. 5 is a flowchart showing steps performed to pre-tune a model using transformed images from an existing image dataset; and

FIG. 6 is a flowchart showing steps performed to fine tune the model by processing images from the model's domain.

### DETAILED DESCRIPTION

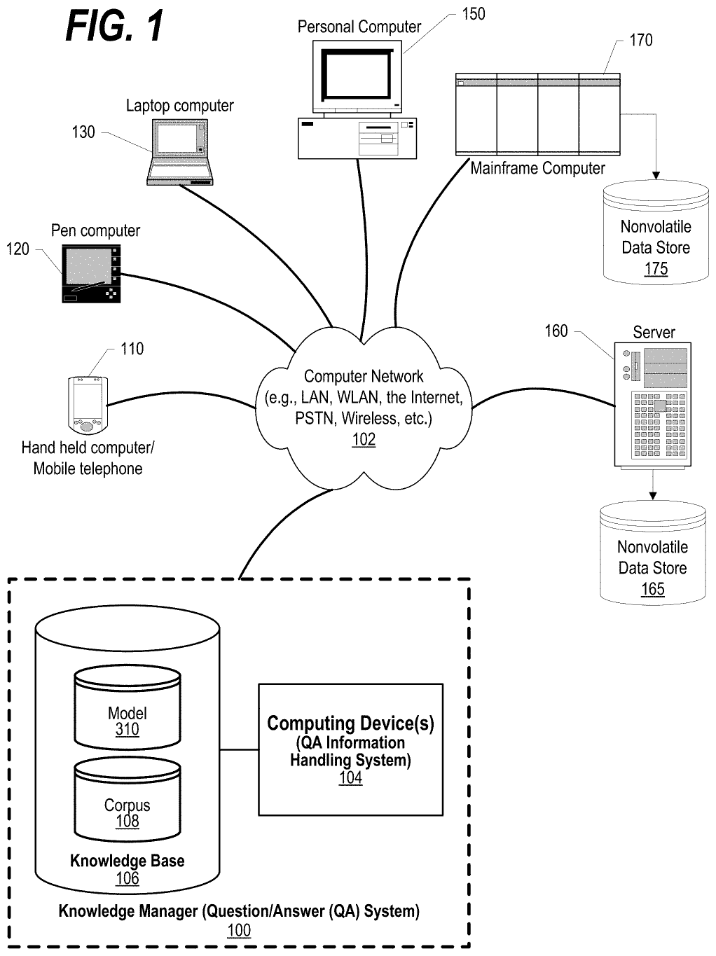

FIGS. 1-6 depict an approach that pre-trains a model using transformed image data from a pre-existing image dataset and then fine tunes the model using image data from the model's domain. As used herein, a “model's domain” is the dataset of annotated images used to train the model to make predictions regarding non-annotated images selected from the domain. Also as used herein, “pre-training” is referred to as “Task #1,” and “fine tuning” is referred to as “Task #2.” This distinction is provided to separate the two distinct tasks, however such distinction is not meant to suggest or imply an order in which the respective tasks are performed, as Task #1 and Task #2 can be performed in any order and can be repetitively performed after the completion of either task in order to further train the model.

During model pre-training, referred to as Task #1, a large labeled image dataset from a source domain is accessed with the large image dataset including a large number of images, most or many of which likely do not pertain to the target domain of the new model that is being created. An example of such a large image dataset is the ImageNet project that is a large visual database that includes millions of images that have been hand-annotated to indicate the objects pictured. A selection of images from the source domain are processed by transforming the images based on the characteristics of the model's target domain. For example, if the model is a model of medical images, such as x-rays, of various patients' chests, the domain of these medical images is noted as being grayscale images, rather than the color (RGB) images of the source domain. The source images are then transformed to images of the target domain. In an embodiment, pixels of the source images are defined in a source pixel data model, e.g. RGB, YCB, and pixels of target domain images are defined in a target pixel data model, e.g., gray scale. A transformation from the source pixel data model to the target pixel data model is performed as a weighted sum of the pixel values following the CCIR 601 standard for LUMA coding. This transformation corrects for the human perception and retains the luminance information while eliminating the hue and saturation information. Other pixel model transformations may be employed for other image modalities or other image types. In this example, the RGB images are transformed into grayscale images. These transformed images are then used to train the model so that the model so that the model can predict, or identify, images from the source domain. Using the medical example from above, at this point the model would likely not be able to predict, or provide answers, based upon chest x-ray images as the model has not yet been trained for this specific medical domain. However, assuming the source domain included many images of automobiles, the model, at this point, could likely predict, or provide, information responsive to a given grayscale image of a particular automobile since the model has been trained with such grayscale images.

During model fine-tuning, referred to as Task #2, a smaller labeled image dataset corresponding to the model's domain is utilized to further train the model. Using the medical example from above, the smaller labeled image dataset might be grayscale images of various patients' chests (e.g., x-rays, etc.) labeled according to the condition or ailment found in the image (e.g., lung cancer, emphysema, etc.). Because images from the model's domain are likely more difficult to acquire than general images from the source domain using during Task #1, this dataset is likely to be smaller than the dataset used to pre-tune the model during Task #1. During the pre-training, the model was trained to analyze grayscale images quite well, just not medical images, while in this fine-tuning phase of Task #2, the model is further trained to analyze grayscale medical images, such as those found in chest x-rays, etc. After fine-tuning, the model is able to predict, or identify, images from the model's domain, such as chest x-rays. To test the model, a chest x-ray with a particular condition is input to the model, such as a chest x-ray of a patient with small cell carcinoma and, if properly trained, the model will be able to predict, or provide, information responsive to the proffered chest x-ray image.

The approach described herein address the difficulty to obtain an image dataset of sufficient size to train an entire convolutional neural network from scratch. A common approach is to pre-train a convolutional neural network on a very large dataset, and then use the convolutional neural network either as an initialization or a fixed feature extractor for the task of interest. This technique is called transfer learning or domain adaptation.

To design a deep learning architecture, the present methods and systems may implement various transfer learning strategies. Examples of such strategies include, but are not limited to: Treating the convolutional neural network as a fixed feature extractor: Given a convolutional neural network pre-trained on ImageNet, the last fully connected layer may be removed, then the convolutional neural network may be treated as a fixed feature extractor for the new dataset. ImageNet is a publicly available image dataset including over 14,000,000 annotated images. The result may be an N-D vector, known as a convolutional neural network code, which contains the activations of the hidden layer immediately before the classifier/output layer. The convolutional neural network code may then be applied to image classification or search tasks as described further below. The approach described herein address improving transfer learning or domain adaptation when dealing with a domain with image characteristics different than those found in ImageNet or other large dataset of images. For example, in a medical environment, the image domain might be grayscale images rather than natural, color images found in ImageNet or other large image dataset. This approach transforms the images found in ImageNet or other large image dataset to characteristics found in the image domain of the model (e.g., grayscale images in the case of a medical implementation, etc.).

Fine-tuning the convolutional neural network: Given an already learned model, the architecture may be adapted and backpropagation training may be resumed from the already learned model weights. One can fine-tune all the layers of the convolutional neural network, or keep some of the earlier layers fixed (due to overfitting concerns) and then fine-tune some higher-level portion of the convolutional neural network. This is motivated by the observation that the earlier features of a convolutional neural network include more generic features (e.g., edge detectors or color blob detectors) that may be useful to many tasks, but later layers of the convolutional neural network becomes progressively more specific to the details of the classes contained in the original dataset.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

FIG. 1 depicts a schematic diagram of one illustrative embodiment of a question/answer (QA) system 100 in a computer network 102. QA system 100 may include knowledge manager 104, which comprises one or more processors and one or more memories, and potentially any other computing device elements generally known in the art including buses, storage devices, communication interfaces, and the like. Computer network 102 may include other computing devices in communication with each other and with other devices or components via one or more wired and/or wireless data communication links, where each communication link may comprise one or more of wires, routers, switches, transmitters, receivers, or the like. QA system 100 and network 102 may enable question/answer (QA) generation functionality for one or more content users. Other embodiments may include QA system 100 interacting with components, systems, sub-systems, and/or devices other than those depicted herein.

QA system 100 may receive inputs from various sources. For example, QA system 100 may receive input from the network 102 and other possible sources of input. In one embodiment, some or all of the inputs to QA system 100 route through the network 102 and stored in knowledge base 106. The various computing devices on the network 102 may include access points for content creators and content users. Some of the computing devices may include devices for a database storing the corpus of data. The network 102 may include local network connections and remote connections in various embodiments, such that QA system 100 may operate in environments of any size, including local and global, e.g., the Internet. Additionally, QA system 100 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly. Knowledge base 106 includes corpus 108 which is data ingested into the QA system, as well as model 310, such as a model of medical imagery used to predict data pertaining to medical images, such as a chest x-ray.

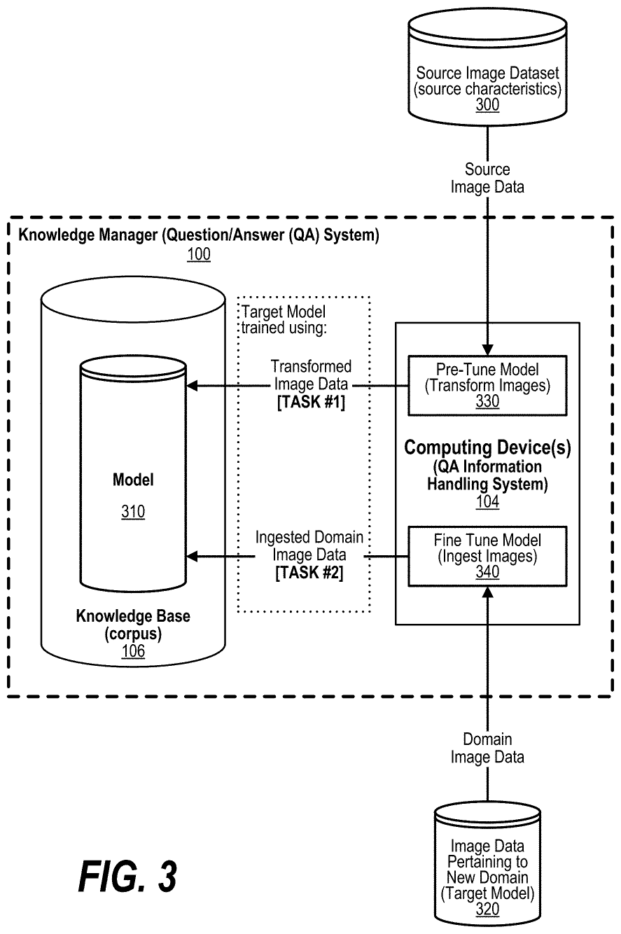

Model 310 is included in the QA system's knowledge base 106. As shown in FIGS. 3-6, model 310 is created by pre-tuning the model using transformed image data and then further trained using image data from the model's domain. For example, if model 310 is a model of grayscale medical images, then the source domain image data is transformed from natural (color) images to grayscale images and used to pre-tune model 310 to analyze grayscale images (but not medical images). Images from the model's domain, such as grayscale medical images (e.g., chest x-rays, etc.) are used to train model 310 so that the model can accurately make predictions based upon grayscale medical images (e.g., a patient's x-ray image, etc.) inputted to QA system 100.

An example of QA system 100 may be the IBM Watson™ QA system available from International Business Machines Corporation of Armonk, N.Y., which is augmented with the mechanisms of the illustrative embodiments described hereafter. The QA knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the QA system. The statistical model may then be used to summarize a level of confidence that the QA system has regarding the evidence that the potential response, i.e. candidate answer, is inferred by the question. This process may be repeated for each of the candidate answers until the QA system identifies candidate answers that surface as being significantly stronger than others and thus, generates a final answer, or ranked set of answers, for the input question.

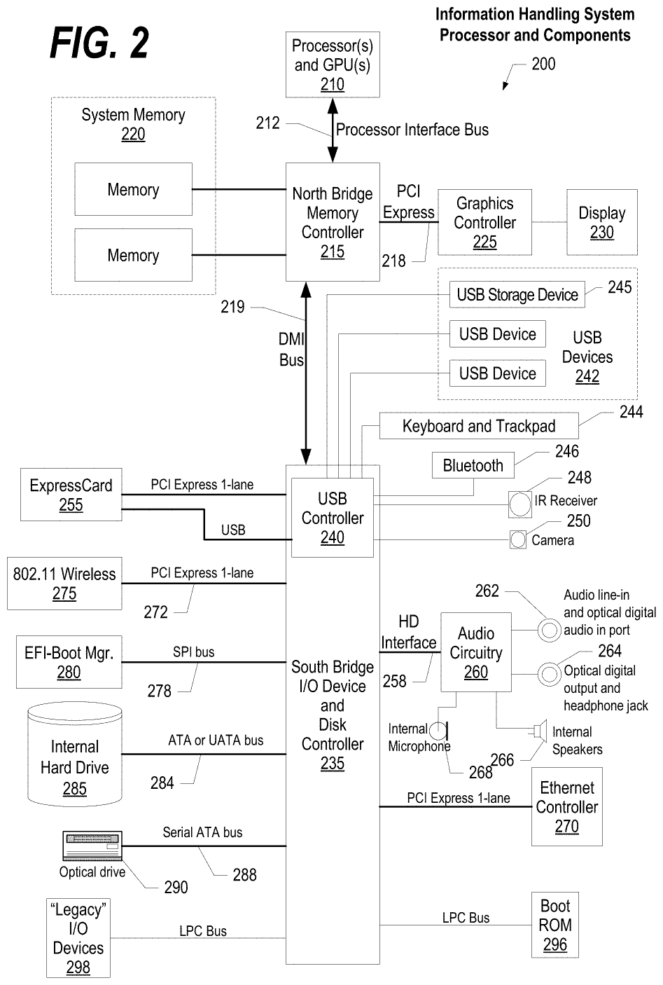

Types of information handling systems that can utilize QA system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 102. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

With benefit of this disclosure, it will be appreciated by those skilled in the art that there are numerous different types of deep learning models in the literature, many of which would benefit using the transformation pre-tuning approach described herein. In one embodiment, a popular model is used, and the transformation approach disclosed herein of transforming the source-domain images, to match the characteristics of the target-domain images is performed to pre-tune the model. This approach can be applied to virtually any deep learning model, because the transformation is done on the data, not on the model itself. Popular models that may be of interest include AlexNet, VGG, Inception, ResNet, and DenseNet. Popular tasks to which this approach applies include classification, detection, and semantic segmentation.

Those skilled in the art will further appreciate that there are multiple ways to construct deep learning models. For images, these are typically convolutional neural networks. Popular “architectures” have been named (model names give above). The transformation and pre-tuning approach shown herein is useful for all of these models.

FIG. 2 illustrates information handling system 200, more particularly, a processor and common components, which is a simplified example of a computer system capable of performing the computing operations described herein. Information handling system 200 includes one or more processors and one or more graphical processing units (GPUs) 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE 0.802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

FIG. 3 is a system diagram depicting the components that may be utilized to facilitate transfer learning through image transformation. Source image dataset 300 includes a large number of annotated images. Few, if any, of the annotated images from the source image dataset are from the domain of model 310 that is being created. In addition, characteristics of images from the domain of model 310 are different than the characteristics of images included in source image dataset 300. For example, in a medical environment, the medical images included in the model's domain are grayscale images, while the images in source image dataset 300 are natural, color images, of objects in the natural world (e.g., dogs, cats, automobiles, etc.). Two tasks are performed to fully train model 310. Task #1 is a pre-tuning task, shown as process 330, that pre-tunes the model. Task #2 is a fine tuning task, shown as process 340, that trains the model to analyze domain-based images (e.g., medical images of a patient's chest x-ray, etc.).

In Task #1, process 330 pre-tunes model 310 by transforming images from source image dataset 300 to images with characteristics found in the model's domain. For example, transforming the natural, color (RGB) images from source image dataset 300 into grayscale images that are found in the domain of the model. Pre-tuning the model results in model 310 being able to accurately analyze grayscale images found in the natural world (e.g., dogs, cats, automobiles, etc.).

In Task #2, process 340 trains model 310 by ingesting annotated images from the model's domain, shown here as data store 320. Because these images are from the model's domain, no transformation is needed and the images are directly used to train model 310. Training the model with these images (e.g., annotated medical images, etc.) results in model 310 being able to accurately analyze images from the model's domain. After training, a user such as a doctor or medical professional, can provide a medical image, such as a chest x-ray, of a patient to QA system 100. The QA system, using model 310, can accurately predict items shown in the provided medical image and provide such predictions back to the medical professional.

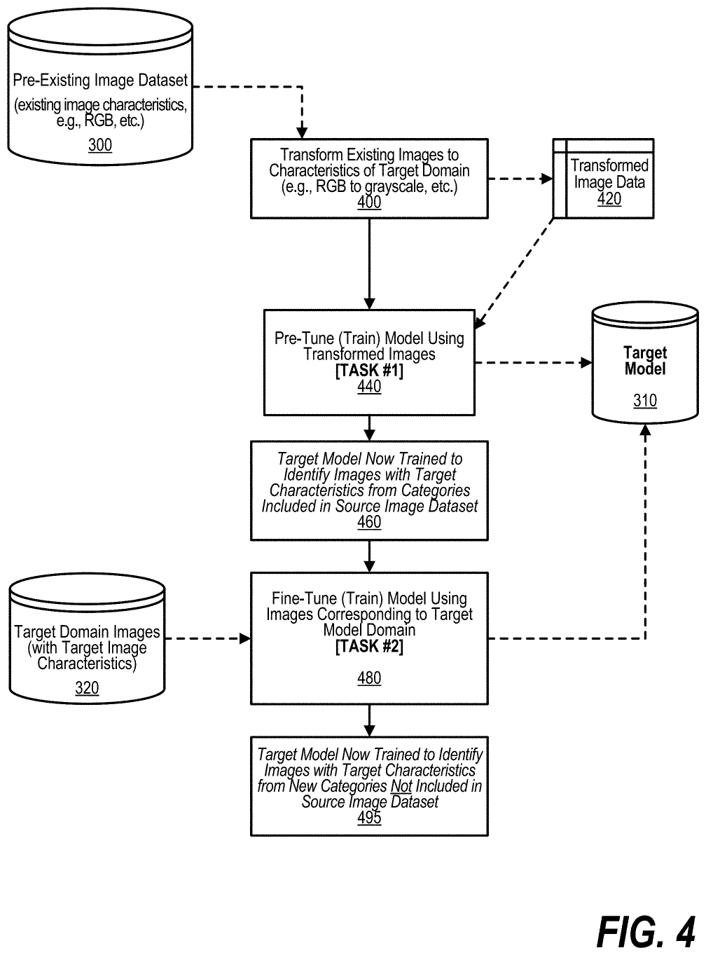

FIG. 4 is a higher level flowchart showing basic steps performed to facilitate transfer learning through image transformation. At step 400, the process transforms existing images received from pre-existing image dataset to characteristics found in the target domain. For example, in developing a model in a medical environment, the pre-existing images in data store 300 might be color (RGB) images, while the target domain's images are grayscale images, such as those found in x-ray images. The transformed image data is stored in memory area 420.

At step 440, the process performs Task #1 whereupon the process pre-tunes, or “trains,” Model 310 using the transformed image data from memory area 420. Box 460 indicates that at this point the model is now trained on how to identify images with target characteristics that are from categories that are included in the source dataset. For example, if the target characteristics are grayscale images, and the source dataset included images of various automobile models, then at this point the model could analyze a grayscale automobile image and predict information, such as the automobile's make and model, of the image.

At step 480, the process performs Task #2 whereupon the process fine-tunes and further trains the model using images corresponding to the target model's domain. Target domain images are retrieved from data store 320 and these images, being in the model's domain, already have the image characteristics so image transformation is not performed. Images in data store 320 are annotated images from the target model's domain. For example, if the target domain is a dataset of grayscale medical images, then data store 320 would include annotated grayscale medical images showing images depicting various conditions and ailments.

Box 495 indicates that at this point the model is now trained to identify images with target characteristics from new categories that were not included in the source dataset. Using the medical example, the model could now be provided an image of a patient's chest x-ray and accurately predict the patient's medical condition shown in such image, such as an indication of small cell carcinoma.

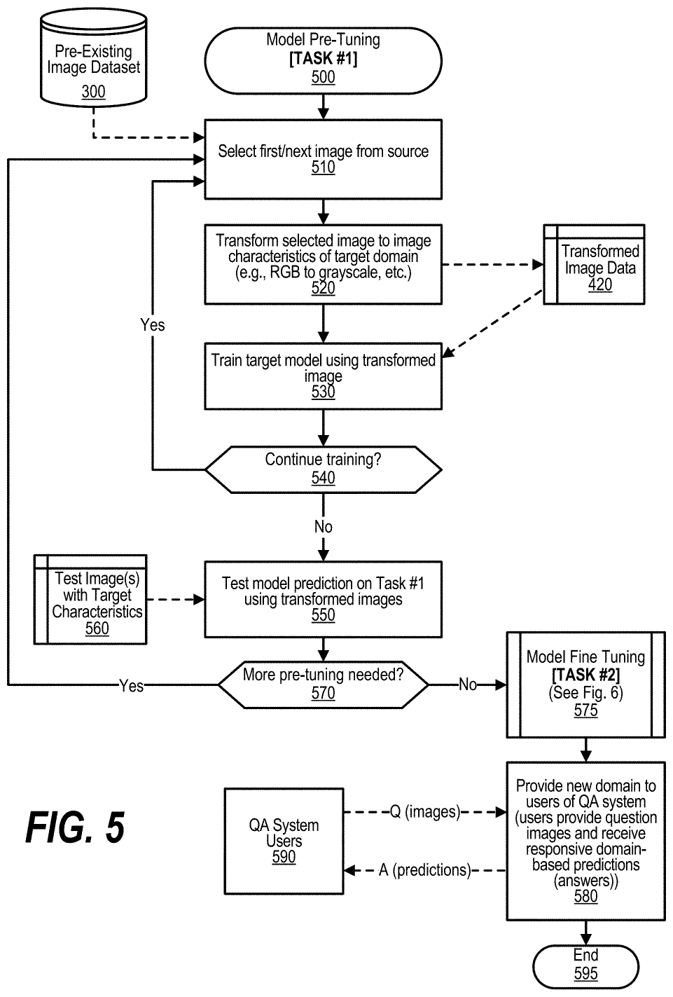

FIG. 5 is a flowchart showing steps performed to pre-tune the model using transformed images from an existing image dataset. FIG. 5 processing commences at 500 and shows the steps taken by a process that performs TASK #1 that pre-tunes a model using transformed image data. At step 510, the process selects the first image from source image dataset 300. The selected image has different characteristics as those found in the model's domain. For example, the source image dataset images might be natural (color) images found in the natural world, while the model's domain, such as a medical environment, might be grayscale images.

At step 520, the process transforms the selected image to image characteristics of the model's domain (e.g., transforming an RGB image to a grayscale image, etc.). The transformed image data is stored in memory area 420. At step 530, the process trains the model using the transformed image data found in memory area 420. The process determines as to whether further pre-tuning (Task #1) processing is needed (decision 540). If further training is needed, then decision 540 branches to the ‘yes’ branch which loops back to step 510 to repeat selection and processing of the next image from data store 300. This looping continues until no further pre-tuning is deemed necessary, at which point decision 540 branches to the ‘no’ branch exiting the loop.

At step 550, the process tests the model prediction on Task #1 using transformed images. For example, if image dataset 300 included images of automobiles, then tests might be performed to determine if the model is sufficiently trained to predict data about grayscale automobile images. The test images are retrieved from memory area 560 and the process determines whether the model is adequately trained to accurately predict data responsive to the test images. The process determines as to whether, based on the testing, more pre-tuning is needed (decision 570). If more pre-tuning is needed, then decision 570 branches to the ‘yes’ branch which loops back to 510 to repeat selection and processing of the next image from data store 300. This looping continues until testing reveals that no further pre-tuning is necessary, at which point decision 570 branches to the ‘no’ branch exiting the loop.

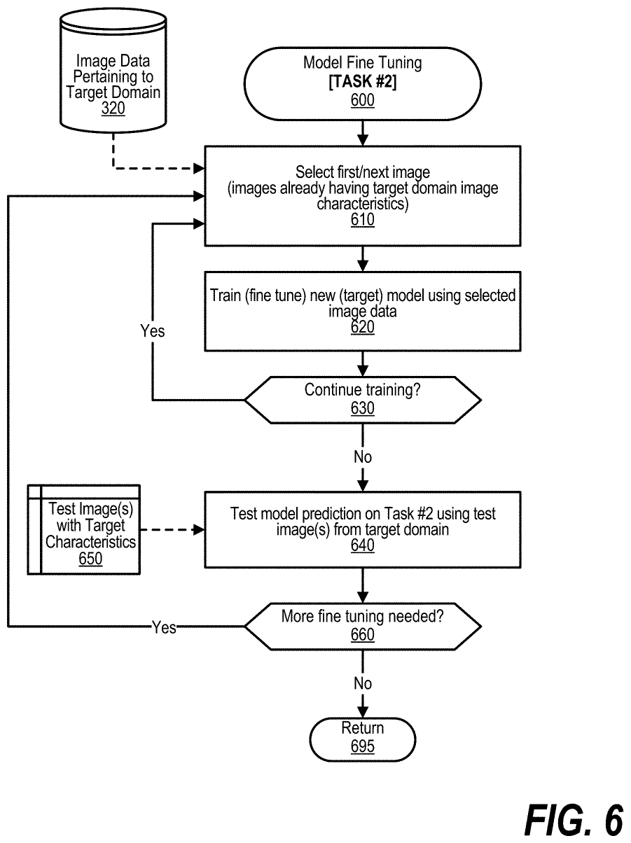

At predefined process 575, the process Task #2, during which the model is fine tuned, is performed (see FIG. 6 and corresponding text for processing details). At step 580, the process provides the new domain (model) to users 590 of the QA system. Users 590 provide questions in the form of images and receive responsive domain-based predictions, or answers. For example, in the medical example discussed throughout, a QA system user might be a doctor that submits a grayscale chest x-ray image of a patient and the QA system, using the model, responds with predictons of the patient's condition, such as whether the patient has lung cancer, etc. FIG. 5 processing thereafter ends at 595.

FIG. 6 is a flowchart showing steps performed to fine tune the model by processing images from the model's domain. FIG. 6 processing commences at 600 and shows the steps taken during Task #2 whereupon a model is fine tuned using domain-specific images. At step 610, the process selects the first image from data store 320. Images in data store 320 already have the target domain image characteristics, such as being grayscale images in the case of a model being developed for a medical environment. In addition, the images in data store 320 are annotated. Using the medical image example, grayscale chest x-ray images of patients with small cell carcinoma, emphysema, etc. are annotated accordingly.

At step 620, the process trains, or fine tunes, the model using the selected image data including its annotation data. The process determines as to whether further training is needed (decision 630). If further training is needed, then decision 630 branches to the ‘yes’ branch which loops back to step 610 to select and process the next image from data store 320. This looping continues until no further training is deemed necessary, at which point decision 630 branches to the ‘no’ branch exiting the loop. At step 640, the process tests model prediction on Task #2 using one or more test images from the target domain. The test images are retrieved from memory area 650 and, in one embodiment, the test images are not annotated. In the medical example used throughout, a test image might be a chest x-ray of a patient. The testing determines whether the trained model accurately analyzed the test images. For example, whether the trained model accurately identified cancer that appeared in a test image.

Based on the testing, the process determines as to whether more fine tuning, or training, of the model is needed (decision 660). If more fine tuning (training) is needed, then decision 660 branches to the ‘yes’ branch which loops back to step 610 to select and process the next image from data store 320. This looping continues until testing reveals that the model accurately analyzes test images, at which point decision 660 branches to the ‘no’ branch exiting the loop. FIG. 6 processing thereafter returns to the calling routine (see FIG. 5) at 695.

The inventors have discovered that a model trained according to the principles described herein advantageously provides better performance (better accuracy) and is also faster in inference than known conventional approaches. For example, processing triplicate input RGB color images results in wasted computation when the color information is subsequently discarded. As another example, a CNN model needs to “unlearn” color kernels. Moreover, the principles may be applied to other image domains to improve accuracy and speed for a wide range of tasks.

In an embodiment, the example model described herein may be a deep learning model based on convolutional neural networks (CNN). Moreover, the techniques and methods described herein can be applied to any deep learning model, including those based on convolutional neural networks, because the transformation is done on the data, not on the model itself. For example, the techniques and methods may be employed with the AlexNet, VGG, Inception, ResNet, DenseNet deep learning models.

While the inventive principles have been described with respect to an example target domain having medical x-ray images, it should be appreciated that the techniques and methods described herein can be applied to other types of images and target image modalities. For example, in medical imaging (ultrasound, Xray, MRI, PET) and other images (infra-red, hyperspectral). Moreover, while the inventive principles have been described with respect to an example question and answer system, it should be appreciated that the techniques and methods described herein can be used by systems to perform classification, detection, semantic segmentation, and other known image recognition operations.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method comprising:
transforming a first plurality of images retrieved from an annotated source image dataset, wherein the transformation is based on one or more image characteristics found in a model's domain;
pre-tuning the model using the transformed plurality of images, wherein the model is included in a question-answering (QA) system;
training the model using a second plurality of annotated images corresponding to the target domain;
receiving, at the QA system, a selected non-annotated image with image characteristics of the target domain; and
providing, by the QA system, one or more predictions pertaining to the selected non-annotated image based on the trained model.

2. The method of claim 1 wherein the first plurality of images are color (RGB) images and one of the image characteristics found in the model's domain is grayscale images, and wherein the transforming changes the first plurality of color images to the transformed plurality of grayscale images.

3. The method of claim 1 wherein the first plurality of images are natural color images and wherein the transformed plurality of images are grayscale images.

4. The method of claim 1 further comprising:
testing the pre-tuning before training the model, wherein the testing includes:
receiving, at the QA system, a test image from the source image dataset, wherein the test image has been transformed based on the image characteristics found in the model's domain;
providing, by the QA system, one or more predictions pertaining to the test image based on the pre-tuned model; and
performing further pre-tuning in response to an incorrect prediction.

5. The method of claim 1 further comprising:
testing the training, wherein the testing includes:
receiving, at the QA system, a test image from the target domain;
providing, by the QA system, one or more predictions pertaining to the test image based on the trained model; and
performing further training in response to an incorrect prediction.

6. The method of claim 1 wherein the model's domain is a set of grayscale medical images and wherein the source image dataset is a non-medical dataset of natural color images.

7. The method of claim 1 further comprising:
performing further pre-tuning of the model after performance of the model training.

8. An information handling system comprising:
one or more processors;
a memory coupled to at least one of the processors;
a set of computer program instructions stored in the memory and executed by at least one of the processors in order to perform actions of:
transforming a first plurality of images retrieved from an annotated source image dataset, wherein the transformation is based on one or more image characteristics found in a model's domain;
pre-tuning the model using the transformed plurality of images, wherein the model is included in a question-answering (QA) system;
training the model using a second plurality of annotated images corresponding to the target domain;
receiving, at the QA system, a selected non-annotated image with image characteristics of the target domain; and
providing, by the QA system, one or more predictions pertaining to the selected non-annotated image based on the trained model.

9. The information handling system of claim 8 wherein the first plurality of images are color (RGB) images and one of the image characteristics found in the model's domain is grayscale images, and wherein the transforming changes the first plurality of color images to the transformed plurality of grayscale images.

10. The information handling system of claim 8 wherein the first plurality of images are natural color images and wherein the transformed plurality of images are grayscale images.

11. The information handling system of claim 8 wherein the actions further comprise:
testing the pre-tuning before training the model, wherein the testing includes:
receiving, at the QA system, a test image from the source image dataset, wherein the test image has been transformed based on the image characteristics found in the model's domain;
providing, by the QA system, one or more predictions pertaining to the test image based on the pre-tuned model; and
performing further pre-tuning in response to an incorrect prediction.

12. The information handling system of claim 8 wherein the actions further comprise:
testing the training, wherein the testing includes:
receiving, at the QA system, a test image from the target domain;
providing, by the QA system, one or more predictions pertaining to the test image based on the trained model; and
performing further training in response to an incorrect prediction.

13. The information handling system of claim 8 wherein the model's domain is a set of grayscale medical images and wherein the source image dataset is a non-medical dataset of natural color images.

14. The information handling system of claim 8 wherein the actions further comprise:
performing further pre-tuning of the model after performance of the model training.

15. A computer program product stored in a computer readable storage medium, comprising computer program code that, when executed by an information handling system, causes the information handling system to perform actions comprising:
transforming a first plurality of images retrieved from an annotated source image dataset, wherein the transformation is based on one or more image characteristics found in a model's domain;
pre-tuning the model using the transformed plurality of images, wherein the model is included in a question-answering (QA) system;
training the model using a second plurality of annotated images corresponding to the target domain;
receiving, at the QA system, a selected non-annotated image with image characteristics of the target domain; and
providing, by the QA system, one or more predictions pertaining to the selected non-annotated image based on the trained model.

16. The computer program product of claim 15 wherein the first plurality of images are color (RGB) images and one of the image characteristics found in the model's domain is grayscale images, and wherein the transforming changes the first plurality of color images to the transformed plurality of grayscale images.

17. The computer program product of claim 15 wherein the first plurality of images are natural color images and wherein the transformed plurality of images are grayscale images.

18. The computer program product of claim 15 wherein the information handling system performs further actions comprising:
testing the pre-tuning before training the model, wherein the testing includes:
receiving, at the QA system, a test image from the source image dataset, wherein the test image has been transformed based on the image characteristics found in the model's domain;
providing, by the QA system, one or more predictions pertaining to the test image based on the pre-tuned model; and
performing further pre-tuning in response to an incorrect prediction.

19. The computer program product of claim 15 wherein the information handling system performs further actions comprising:
testing the training, wherein the testing includes:
receiving, at the QA system, a test image from the target domain;
providing, by the QA system, one or more predictions pertaining to the test image based on the trained model; and
performing further training in response to an incorrect prediction.

20. The computer program product of claim 15 wherein the model's domain is a set of grayscale medical images and wherein the source image dataset is a non-medical dataset of natural color images.
